(19) United States
(12) Patent Application Publication
(10) Pub. No.: US 2024/0323830 A1
(43) Pub. Date: Sep. 26, 2024

(54) WIRELESS TRANSCEIVER DEVICE AND WIRELESS TRANSMISSION MODE SWITCHING METHOD

(71) Applicant: Realtek Semiconductor Corporation, Hsinchu (TW)

(72) Inventors: Der-Zheng LIU, Hsinchu (TW); Wei-Hsuan CHANG, Hsinchu (TW)

(21) Appl. No.: 18/605,795

(22) Filed: Mar. 14, 2024

(30) Foreign Application Priority Data
Mar. 25, 2023 (TW) 112111380

(51) Int. Cl. H04W 48/20; H04W 72/044; H04W 72/542

(52) U.S. Cl. CPC H04W 48/20; H04W 72/0473; H04W 72/542

(57) ABSTRACT

A wireless transceiver device includes a communication module and a processor. The communication module is used for receiving and transmitting radio frequency signals. The processor is coupled to the communication module and configured to perform the following operations in accordance with a predetermined condition: determining candidate transmission modes according to a current transmission mode of the communication module, in which a packet error rate of the communication module is less than an error rate threshold in each candidate transmission mode; and determining one of the candidate transmission modes with a least power consumption value as a subsequent transmission mode of the communication module.

### RELATED APPLICATIONS

This application claims priority to Taiwan Application Serial Number 112111380, filed Mar. 25, 2023, which is herein incorporated by reference.

### BACKGROUND

### Technical Field

The present disclosure relates to transmission mode switching, and more particularly to a wireless transceiver device with a transmission mode switching function and a wireless transmission mode switching method.

### Description of Related Art

Selection of packet transmission rate is the key to effectively using channel bandwidth and improving transmission performance in a wireless communication system, in which the transmission performance is increased as the data transmission rate is higher. For a wireless transceiver device (e.g., a smartphone, a tablet or a wearable device) powered mainly by an internal battery, performance optimization may be set with a higher priority in the system settings thereof when being powered by an external power source. However, after the external power source is disconnected, the higher priority in the system settings usually changes to power saving for lengthening the usage time, and as such, the transmission performance significantly drops and thus affects user experience. Therefore, how to simultaneously meet the requirements of the transmission performance as well as the power consumption in the power saving mode for the wireless transceiver device is a major objective in the related industries.

### SUMMARY

One aspect of the present disclosure directs to a wireless transceiver device which includes a communication module and a processor. The communication module used for transmitting and receiving radio frequency (RF) signals. The processor is coupled to the communication module and configured to perform the following operations in accordance with a predetermined condition: determining a plurality of candidate transmission modes according to a current transmission mode of the communication module, in which a packet error rate (PER) of the communication module is less than an error rate threshold in each of the plurality of candidate transmission modes; and determining a selected transmission mode with a least power consumption value from the plurality of candidate transmission modes as a subsequent transmission mode of the communication module.

Another aspect of the present disclosure directs to a wireless transmission mode switching method adapted to a wireless transceiver device. The wireless transmission mode switching method includes: determining a plurality of candidate transmission modes according to a current transmission mode of the wireless transceiver device in accordance with a predetermined condition, in which a packet error rate (PER) of the wireless transceiver device is less than an error rate threshold in each of the plurality of candidate transmission modes; and determining a selected transmission mode with a least power consumption from the plurality of candidate transmission modes as a subsequent transmission mode of the wireless transceiver device.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic circuit block diagram of a wireless transceiver device in accordance with some embodiments of the present disclosure.

FIG. 3A shows a transmission rate and power tables for transmissions in a wireless channel with a 40 MHz bandwidth by utilizing Very High Throughput (VHT) modes and various modulation and coding scheme (MCS) indices in one example of the present disclosure.

FIG. 3B shows a transmission rate and power tables for transmissions in a wireless channel with a 80 MHz bandwidth by utilizing VHT modes and various MCS indices in one example of the present disclosure.

FIG. 4 is a flowchart of a wireless transmission mode switching method in accordance with some embodiments of the present disclosure.

FIG. 5 is a flowchart of a wireless transmission mode switching method in accordance with some embodiments of the present disclosure.

FIG. 6 shows a candidate transmission mode switching table in one example of the present disclosure.

FIG. 7 shows a candidate transmission mode switching table in another example of the present disclosure.

FIG. 8 shows a transmission rate and power table for transmissions in a wireless channel with a 40 MHz bandwidth by utilizing High Throughput (HT) modes and various MCS indices in one example of the present disclosure.

### DETAILED DESCRIPTION

The detailed explanation of the present disclosure is described as following. The described preferred embodiments are presented for purposes of illustrations and description, and they are not intended to limit the scope of the present disclosure.

In the present disclosure, the wireless transceiver device may be implemented in various embodiments, including but not limited to a mobile wireless transceiver device such as a station (STA), a notebook, a mobile phone and a tablet and/or a fixed wireless transceiver device such as an access point (AP), a router, a switch, a computer device, a server device and a workstation. In addition, in the embodiments of the present disclosure, a transmission rate and power table and/or a candidate transmission mode switching table may be pre-created and stored in the memory of the wireless transceiver device. The transmission rate and power table includes information of transmission modes and corresponding transmission rates and transmission powers, which can be pre-created through measurement and calculation. The candidate transmission mode switching table includes a list of current transmission modes and corresponding candidate transmission modes, which can be pre-created according to the product design requirement of the wireless transceiver device.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, and High Efficiency (HE) modes, in which the HT modes, the VHT modes, and the HE modes respectively correspond to various generations of wireless local area network standard such as Wi-Fi 4, Wi-Fi 5, and Wi-Fi 6. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

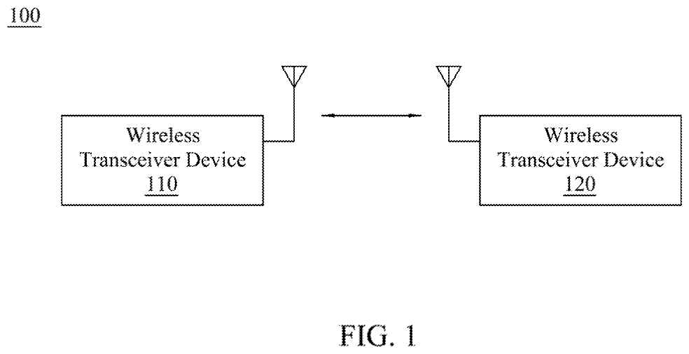

Referring to FIG. 1, FIG. 1 is a schematic diagram of a wireless communication system 100 in accordance with some embodiments of the present disclosure. The communication technology adopted in the wireless communication system 100 may be, for example, a wireless local area network (WLAN) communication technology in compliance with IEEE 802.11 standards (including IEEE 802.11ac, IEEE 802.11ax, etc.) and/or another suitable wireless communication technology. The wireless communication system 100 includes wireless transceiver devices 110 and 120 that are connected through a wireless channel. The wireless channel in the wireless communication system 100 may support multiple-input multiple-output (MIMO), multiple-input single-output (MISO), single-input multiple-output (SIMO), and/or single-input single-output (SISO) transmissions between the wireless transceiver devices 110 and 120.

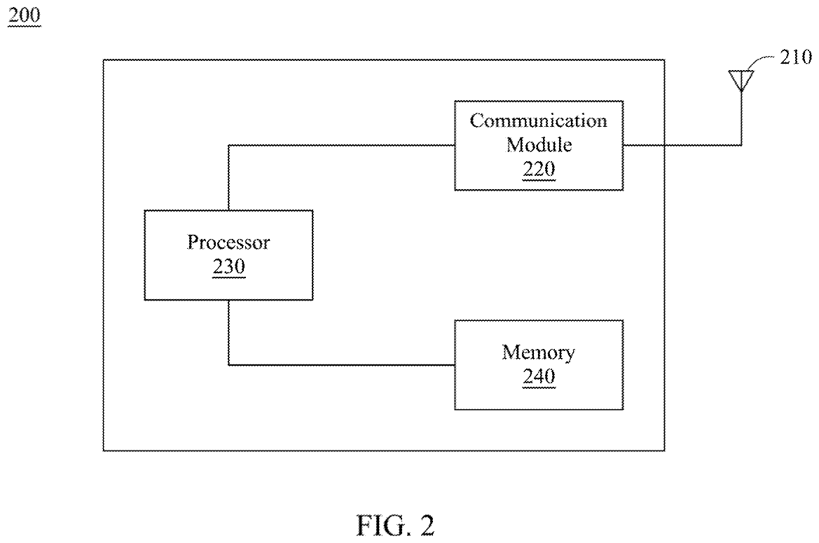

FIG. 2 is a block diagram of a wireless transceiver device 200 in accordance with some embodiments of the present disclosure. The wireless transceiver device 200 may be the wireless transceiver device 110 and/or 120 in FIG. 1. The wireless transceiver device 200 includes an antenna 210, a communication module 220, a processor 230 and a memory 240. The antenna 210 is arranged for radio frequency (RF) signal transmissions and receptions. In some embodiments, the wireless transceiver device 200 may include multiple antennas 210 that can be used for multiple-input and/or multiple-output RF signal transmissions and receptions. The communication module 220 is coupled to the antenna 210, and is used for receiving and demodulating the RF signals into data packets as well as modulating the data packets into the RF signals. The processor 230 is coupled to the communication module 220 and the memory 240, and is configured to process the data packets and determine a transmission mode of the communication module 220 according to system configurations for signal transmissions and receptions. The processor 230 may be, for example, a conventional processor, a multi-core processor, a digital signal processor (DSP), a microprocessor, or an application-specific integrated circuit (ASIC), but is not limited thereto. The memory 240 may be any data storage device that can be read and executed by the processor 230. The memory 240 may be, for example, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid state drive, a flash, or another data storage device suitable for storing bit data and/or program codes, but is not limited thereto. In the embodiments of the present disclosure, the memory 240 may also be configured to store the transmission rate and power table and/or the candidate transmission mode switching table to which the processor 230 refers when switching the transmission mode of the communication module 220.

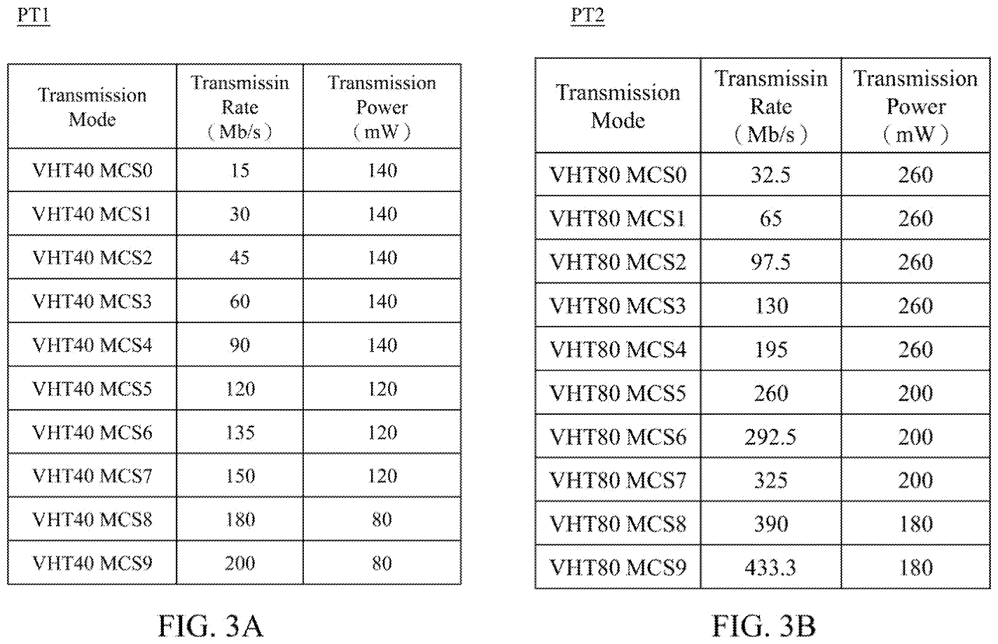

FIG. 3A shows a transmission rate and power table PT1 for transmissions in a wireless channel with a 40 MHz bandwidth by utilizing VHT modes and various modulation and coding scheme (MCS) indices in one example of the present disclosure. FIG. 3B shows a transmission rate and power table PT2 for transmissions in a wireless channels with a 80 MHz bandwidth by utilizing VHT modes and various MCS indices in one example of the present disclosure. In the transmission rate and power tables PT1 and PT2, VHT40 MCS0 transmission mode corresponds to a VHT transmission with an MCS index of 0 in a wireless channel with a channel bandwidth of 40 MHz, VHT80 MCS0 transmission mode corresponds to a VHT transmission with an MCS index of 0 in a wireless channel with a channel bandwidth of 80 MHz, VHT80 MCS1 transmission mode corresponds to a VHT transmission with an MCS index of 1 in a wireless channel with a channel bandwidth of 80 MHz, and the like. According to the transmission rate and power tables PT1 and PT2, for the same channel bandwidth, a VHT transmission mode with a higher MCS index has a higher transmission rate, and the required transmission power thereof remains the same or becomes lower. In an example of the transmission rate and power table PT1, the transmission power of VHT40 MCS8 transmission mode is less than the transmission power of VHT40 MCS7 transmission mode, and the transmission power of VHT40 MCS9 transmission mode is equal to the transmission power of VHT40 MCS8 transmission mode.

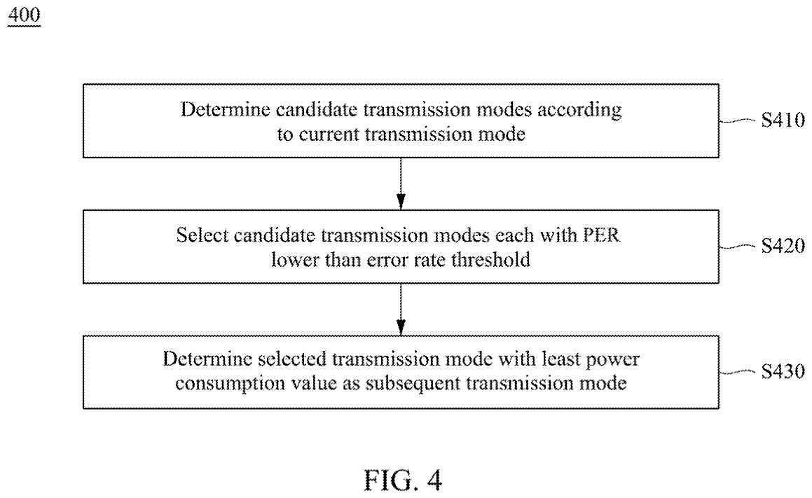

FIG. 4 is a flowchart of a wireless transmission mode switching method 400 in accordance with some embodiments of the present disclosure. The wireless transmission mode switching method 400 may be adopted in the wireless transceiver devices 110 or 120 in FIG. 1, the wireless transceiver device 200 in FIG. 2, or another suitable wireless transceiver device. For example, in an implementation of the wireless transceiver device 200, the wireless transmission mode switching method 400 may be performed by the processor 230. The wireless transmission mode switching method 400 may be triggered when, for example, a usage scenario, a power consumption strategy, a current traffic throughput, a channel loading and/or a current packet error rate (PER) meets a predetermined condition, e.g., that a power supply status of a wireless transceiver device changes from external power source charging to battery charging, that a wireless channel usage rate is less than a usage rate threshold, or that a packet length increases, but is not limited thereto.

In the wireless transmission mode switching method 400, Operation S410 is performed first, in which multiple candidate transmission modes for different bandwidths are determined according to the current transmission mode of the wireless transceiver device. The determined candidate transmission modes have the same MCS index, and correspond to multiple (e.g., fully or partially different) channel bandwidths, such as channel bandwidths of 20 MHz, 40 MHz, and 80 MHz. In addition, the MCS index of the determined candidate transmission modes is larger than the MCS index of the current transmission mode. Operation S420 is then performed to select candidate transmission modes each with a packet error rate (PER) lower than an error rate threshold, i.e., retain the candidate transmission modes each with a PER lower than the error rate threshold but remove the candidate transmission modes each with a PER higher than the error rate threshold. Thereafter, Operation S430 is performed to determine (e.g., select) a transmission mode with a least power consumption value from the candidate transmission modes each with a PER lower than the error rate threshold, such that the wireless transceiver device may switch to the determined transmission mode for subsequent wireless signal transmissions and receptions, thereby achieving power saving.

The wireless transmission mode switching method 400 is exemplified in the following description. If the PER of the wireless transceiver device is extremely low (e.g., less than 5%) in VHT80 MCS7 transmission mode, the MCS index may be increased to 8 for increasing the transmission rate, and thus the candidate transmission modes may include VHT20 MCS8, VHT40 MCS8, and VHT80 MCS8 transmission modes. Then, the wireless transceiver device performs transmissions with the same number of packets in VHT20 MCS8, VHT40 MCS8, and VHT80 MCS8 transmission modes, so as to obtain the PERs respectively corresponding to these candidate transmission modes. If the PER in VHT20 MCS8 transmission mode is 20% and is higher than the error rate threshold (e.g., 10%) while the PER in each of VHT40 MCS8 and VHT80 MCS8 transmission modes does not exceed the error rate threshold, VHT40 MCS8 and VHT80 MCS8 transmission modes are retained, but VHT20 MCS8 transmission mode is removed. Lastly, the power consumption values of packet transmissions in VHT40 MCS8 and VHT80 MCS8 transmission modes are calculated by the processor. In detail, it may be obtained by inquiring the transmission rate and power tables PT1, PT2 that the transmission rate and the transmission power of VHT40 MCS8 transmission mode are respectively 180 Mb/s and 80 mW and that the transmission rate and the transmission power of VHT80 MCS8 transmission mode are respectively 390 Mb/s and 180 mW. Then, the processor calculates the power consumption values per 1000-bit packet in VHT40 MCS8 and VHT80 MCS8 transmission modes, which are respectively 1000 bits÷180 Mb/s×80 mW=444.4 nJ and 1000 bits÷390 Mb/s×180 mW=461.5 nJ. When minimization of power compensation has a high priority consideration, VHT40 MCS8 transmission mode is determined as the transmission mode of the wireless transceiver device for subsequent wireless signal transmissions and receptions.

Furthermore, the transmission mode adapted to perform subsequent wireless transmissions and receptions may be determined from more candidate transmission modes according to various MCS indices and communication modes corresponding to various generations of communication standards (including but not limited to VHT, HT, and HE modes) in addition to channel bandwidths, to achieve better power saving performance. For example, a narrower channel bandwidth may accompany with better signal-to-noise ratio (SNR) performance and anti-interference capability, and thus may cooperate with a higher MCS index for further improving power saving performance.

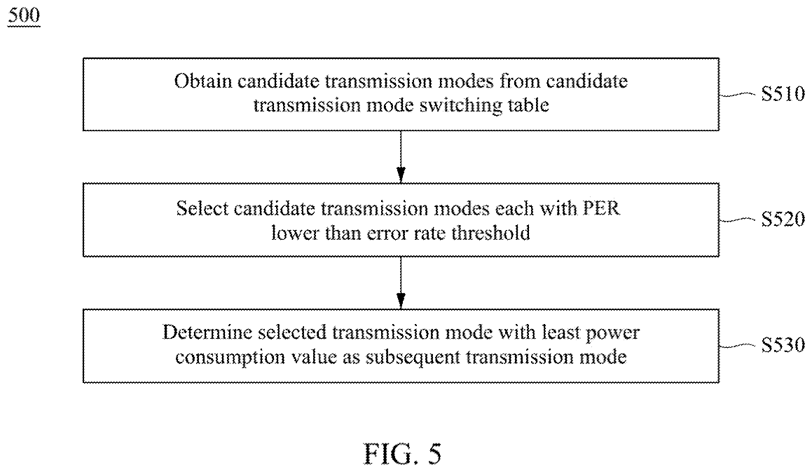

FIG. 5 is a flowchart of a wireless transmission mode switching method 500 in accordance with some embodiments of the present disclosure. Similarly, the wireless transmission mode switching method 500 may be used in the wireless transceiver devices 110 and 120 in FIG. 1, the wireless transceiver device 200 in FIG. 2, or another suitable wireless transceiver device, and may be trigger when, for example, a usage scenario, a power consumption strategy, a current traffic throughput, a channel loading and/or a current PER meets a predetermined condition, e.g., that the power supply status of a wireless transceiver device changes from external power source charging to battery charging, that a wireless channel usage rate is less than a usage rate threshold, or that a packet length increases, but is not limited thereto.

In the wireless transmission mode switching method 500, Operation S510 is firstly performed to obtain multiple candidate transmission modes from a candidate transmission mode switching table according to the current transmission mode of the wireless transceiver device. The obtained candidate transmission modes may correspond to the same MCS index and channel bandwidth, or alternatively may correspond to multiple (e.g., fully or partially different) MCS indices and/or multiple (e.g., fully or partially different) channel bandwidths. The candidate transmission mode switching table may be pre-created and stored in a memory. Operation S520 is then performed to select the candidate transmission modes each with a PER lower than an error rate threshold, i.e., retain the candidate transmission modes each with a PER lower than the error rate threshold but remove the candidate transmission modes each with a PER higher than the error rate threshold. Thereafter, Operation S530 is performed to determine a transmission mode with a least power consumption value from the candidate transmission modes each with the PER less than the error rate threshold, such that the wireless transceiver device switches to the determined transmission mode for subsequent wireless signal transmissions and receptions, thereby achieving power saving.

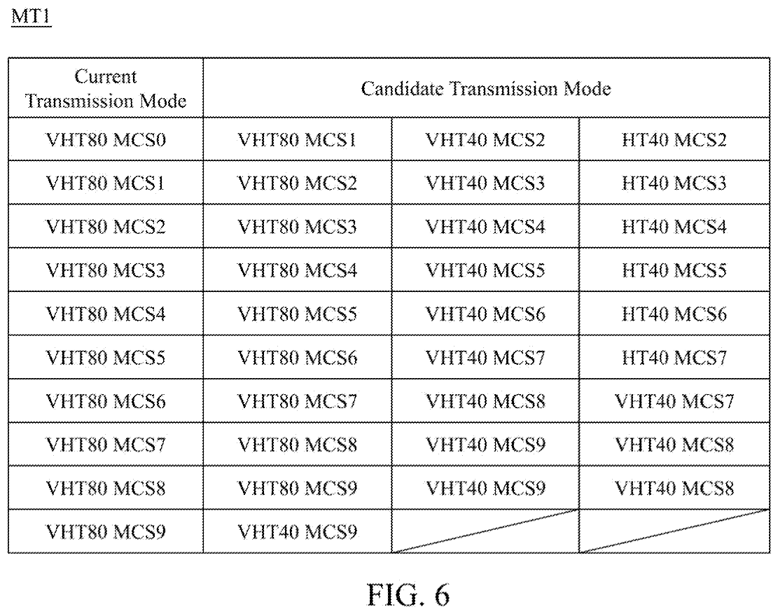

FIG. 6 shows a candidate transmission mode switching table MT1 for determining available candidate transmission modes when the wireless transceiver device performs transmission mode switching in accordance with a specific condition (e.g., extremely low PER or that power saving in the system settings is set to a higher priority), in one example of the present disclosure. For example, if the current transmission mode of the wireless transceiver device is VHT80 MCS7 transmission mode, the available candidate transmission modes for switching include VHT80 MCS8, VHT40 MCS9, and VHT40 MCS8 transmission modes, according to the candidate transmission mode switching table MT1 shown in FIG. 6.

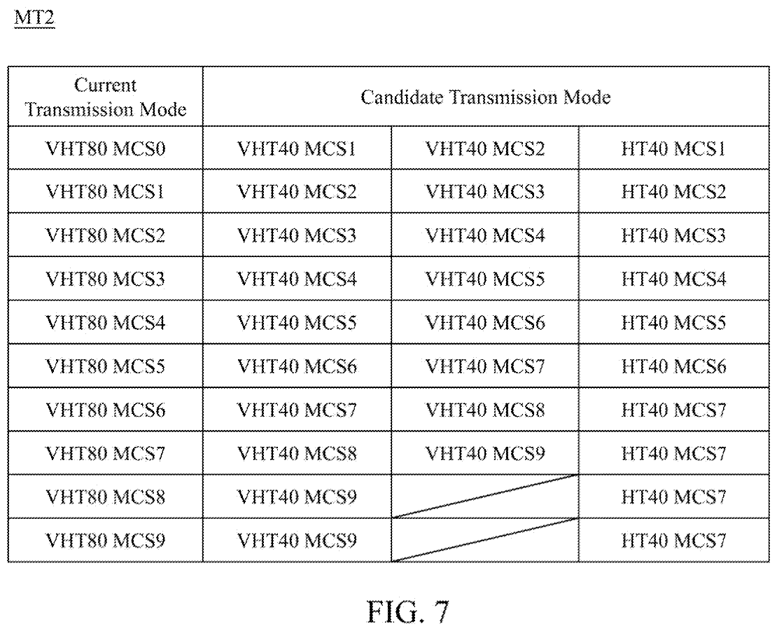

The wireless transceiver device may also perform transmission mode switching by referring to various candidate transmission mode switching tables. FIG. 7 shows a candidate transmission mode switching table MT2 in another example of the present disclosure. For example, if the current transmission mode of the wireless transceiver device is VHT80 MCS4 transmission mode, the switchable candidate transmission modes include VHT80 MCS5, VHT40 MCS6, and HT40 MCS5 transmission mode according to the candidate transmission mode switching table MT2 shown in FIG. 7. In particular, in the candidate transmission mode switching table MT2 shown in FIG. 7, the channel bandwidth corresponding to each current transmission mode is 80 MHz, and the channel bandwidth corresponding to each candidate transmission mode is 40 MHz. Therefore, if the candidate transmission mode switching table MT2 is adopted, the wireless transceiver device certainly performs wireless transmissions and receptions in a transmission channel with a narrower channel bandwidth after the transmission mode switching.

It is noted that in the present disclosure, the contents of the candidate transmission mode switching table may be modified according to system design requirements, but is not limited to the candidate transmission mode switching tables MT1 and MT2 shown in FIGS. 6 and 7. For example, if the wireless transceiver device supports generations of communication standard such as HT and HE, the transmission modes corresponding to generations of communication standard such as HT and HE may be added in the column of current transmission modes, and correspondingly the candidate transmission modes may also be modified to include HE transmission modes. In addition, the number of available candidate transmission modes for switching may also be increased or decreased according to system design requirements.

In the following description, the candidate transmission mode switching table MT1 shown in FIG. 6 is exemplified to describe the wireless transmission mode switching method 500. If the PER of the wireless transceiver device currently operated in VHT80 MCS7 transmission mode is extremely low, the wireless transceiver device may determine to switch to another transmission mode for further reducing power consumption. The available candidate transmission modes obtained by inquiring the candidate transmission mode switching table MT1 include VHT80 MCS8, VHT40 MCS9, and VHT40 MCS8 transmission modes. Then, the wireless transceiver device performs transmissions with the same number of packets in VHT80 MCS8, VHT40 MCS9, and VHT40 MCS8 transmission modes to obtain the PERs respectively corresponding to the candidate transmission modes. If neither of the PERs of the candidate transmission modes exceeds the error rate threshold, the processor then calculates the power consumption values for packet transmissions in the candidate transmission modes. In detail, it may be obtained by inquiring the transmission rate and power tables PT1 and PT2 that the transmission rate and the transmission power of VHT80 MCS8 transmission mode are respectively 390 Mb/s and 180 mW, that the transmission rate and the transmission power of VHT40 MCS8 transmission mode are respectively 180 Mb/s and 80 mW, and that the transmission rate and the transmission power of VHT40 MCS8 transmission mode are respectively 180 Mb/s and 80 mW. Then, the processor calculates the power consumption values per 1000-bit packet in VHT80 MCS8, VHT40 MCS9, and VHT40 MCS8 transmission modes, which are respectively 1000 bits÷390 Mb/s×180 mW=461.5 nJ, 1000 bits÷200 Mb/s×80 mW=400.0 nJ, and 1000 bits÷180 Mb/s×80 mW=444.4 nJ. When minimization of power compensation has a high priority consideration, VHT40 MCS9 transmission mode is determined as the transmission mode of the wireless transceiver device for subsequent wireless signal transmissions and receptions.

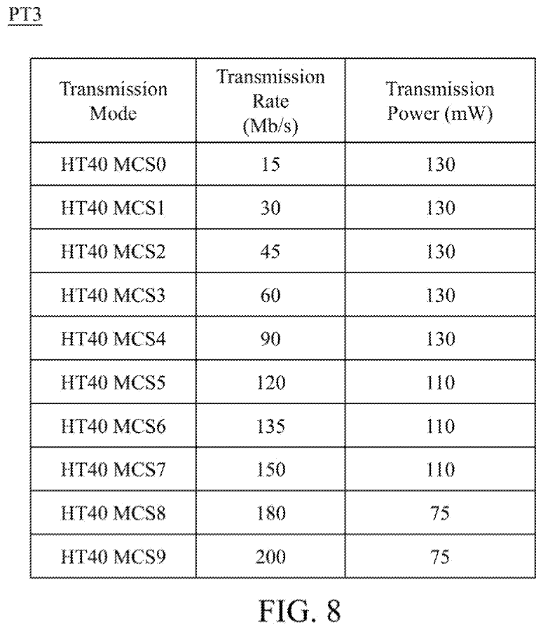

On the other hand, in another example in which the candidate transmission mode switching table MT2 shown in FIG. 7 is exemplified to describe the wireless transmission mode switching method 500, if the PER of the wireless transceiver device currently operated in VHT80 MCS0 transmission mode is extremely low, the wireless transceiver device may determine to switch to another transmission mode for further reducing power consumption. The available candidate transmission modes obtained by inquiring the candidate transmission mode switching table MT2 include VHT40 MCS1, VHT40 MCS2, and HT40 MCS1 transmission modes. Then, the wireless transceiver device performs transmissions with the same number of packets (e.g., 20 packets for each transmission) in VHT40 MCS1, VHT40 MCS2, and VHT40 MCS1 transmission modes, so as to obtain the PERs respectively corresponding to the candidate transmission modes. If the PER in VHT40 MCS2 transmission mode is 75% that exceeds the error rate threshold (e.g., 10%) while neither of the PERs respectively in VHT40 MCS8 and VHT80 MCS8 transmission modes exceeds the error rate threshold, the candidate transmission modes of VHT40 MCS1 and HT40 MCS1 transmission modes are retained, but VHT40 MCS2 transmission mode is removed. Lastly, the processor calculates the power consumption values for packet transmissions in VHT40 MCS1 and HT40 MCS1 transmission modes. In detail, it may be obtained by inquiring the transmission rate and power table PT1 to obtain that the transmission rate and the transmission power of VHT40 MCS1 transmission mode are respectively 30 Mb/s and 140 mW, and it may be obtained by inquiring a transmission rate and power table PT3 shown in FIG. 8 to obtain that the transmission rate and the transmission power of HT40 MCS1 transmission mode are respectively 30 Mb/s and 130 mW. Then, the processor calculates the power consumption values per 1000-bit packet for VHT40 MCS1 and HT40 MCS1 transmission modes, which are respectively 1000 bits÷30 Mb/s×140 mW=4.667 μJ and 1000 bits÷30 Mb/s×130 mW=4.333 μJ. When minimization of power compensation has a high priority consideration, HT40 MCS1 transmission mode is determined as a transmission mode of the wireless transceiver device for subsequent wireless signal transmissions and receptions.

As can be seen from the above description, in the embodiments of the present disclosure, the transmission mode may be switched according to a specific condition for reducing power consumption. In particular, for a wireless transceiver device powered mainly by an internal battery, performance optimization may be set as a high priority in the system settings thereof when being powered by an external power source. However, after the external power source is disconnected, the high priority in the system settings usually changes to power saving for lengthening usage time of the wireless transceiver device. In the embodiments of the present disclosure, the transmission mode can be switched when power saving has a high priority consideration, and one of candidate transmission modes with a least power consumption value is determined as the transmission mode after switching. Therefore, embodiments of the present disclosure may simultaneously meet transmission efficiency and optimize power consumption when minimization of power compensation has a high priority consideration.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A wireless transceiver device, comprising:
a communication module used for transmitting and receiving radio frequency (RF) signals; and
a processor coupled to the communication module and configured to perform the following operations in accordance with a predetermined condition:
determining a plurality of candidate transmission modes according to a current transmission mode of the communication module, wherein in each of the plurality of candidate transmission modes, a packet error rate (PER) of the communication module is less than an error rate threshold; and
determining a selected transmission mode with a least power consumption value from the plurality of candidate transmission modes as a subsequent transmission mode of the communication module.

2. The wireless transceiver device of claim 1, wherein the plurality of candidate transmission modes corresponds to the same modulation and coding scheme (MCS) index and the same generation of communication standard, and correspond to a plurality of channel bandwidths.

3. The wireless transceiver device of claim 1, wherein a first MCS index corresponding to the current transmission mode is less than a second MCS index corresponding to each of the plurality of candidate transmission modes.

4. The wireless transceiver device of claim 1, wherein the plurality of candidate transmission modes correspond to at least two generations of communication standard.

5. The wireless transceiver device of claim 1, wherein the processor is configured to inquiry a candidate transmission mode switching table to determine the plurality of candidate transmission modes according to the current transmission mode.

6. The wireless transceiver device of claim 1, wherein that the processor determines the plurality of candidate transmission modes comprises:
configuring the communication module to transmit the same number of packets sequentially in the plurality of candidate transmission modes, so as to obtain the PER in each of the plurality of candidate transmission modes; and
removing at least one of the plurality of candidate transmission modes of which the PER is higher than the error rate threshold.

7. The wireless transceiver device of claim 1, wherein that the processor determines the selected transmission mode with the least power consumption value comprises:
inquiring at least one transmission rate and power table to obtain a plurality of transmission rates and a plurality of transmission powers respectively corresponding to the plurality of candidate transmission modes; and
calculating the plurality of transmission rates and the plurality of transmission powers to obtain a plurality of power consumption values respectively corresponding to the plurality of candidate transmission modes, wherein a least one of the plurality of power consumption values is the least power consumption value.

8. The wireless transceiver device of claim 1, wherein the predetermined condition includes that a power supply status of the wireless transceiver device changes from external power source charging to battery charging.

9. The wireless transceiver device of claim 1, wherein the predetermined condition includes that a wireless channel usage rate of the communication module is less than a usage rate threshold.

10. The wireless transceiver device of claim 1, wherein a first channel bandwidth to which the current transmission mode corresponds is wider than a second channel bandwidth to which each of the plurality of candidate transmission modes corresponds.

11. A wireless transmission mode switching method adapted to a wireless transceiver device, the wireless transmission mode switching method comprising:
determining a plurality of candidate transmission modes according to a current transmission mode of the wireless transceiver device in accordance with a predetermined condition, wherein in each of the plurality of candidate transmission modes, a PER of the wireless transceiver device is less than an error rate threshold; and
determining a selected transmission mode with a least power consumption from the plurality of candidate transmission modes as a subsequent transmission mode of the wireless transceiver device.

12. The wireless transmission mode switching method of claim 11, wherein the plurality of candidate transmission modes corresponds to the same MCS index and the same generation of communication standard, and correspond to a plurality of channel bandwidths.

13. The wireless transmission mode switching method of claim 11, wherein a first MCS index corresponding to the current transmission mode is less than a second MCS index corresponding to each of the plurality of candidate transmission modes.

14. The wireless transmission mode switching method of claim 11, wherein the plurality of candidate transmission modes correspond to at least two generations of communication standard.

15. The wireless transmission mode switching method of claim 11, wherein the plurality of candidate transmission modes are determined by inquiring a candidate transmission mode switching table according to the current transmission mode.

16. The wireless transmission mode switching method of claim 11, wherein determining the plurality of candidate transmission modes comprises:
configuring the wireless transceiver device to perform transmissions with the same number of packets sequentially in the plurality of candidate transmission modes to obtain the PER in each of the plurality of candidate transmission modes; and
removing at least one of the plurality of candidate transmission modes of which the PER is higher than the error rate threshold.

17. The wireless transmission mode switching method of claim 11, wherein determining the selected transmission mode with the least power consumption value comprises:
inquiring at least one transmission rate and power table to obtain a plurality of transmission rates and a plurality of transmission powers respectively corresponding to the plurality of candidate transmission modes; and
calculating the plurality of transmission rates and the plurality of transmission powers to obtain a plurality of power consumption values respectively corresponding to the plurality of candidate transmission modes, wherein one of the plurality of power consumption values is the least power consumption value.

18. The wireless transmission mode switching method of claim 11, wherein the predetermined condition includes that a power supply status of the wireless transceiver device changes from external power source charging to battery charging.

19. The wireless transmission mode switching method of claim 11, wherein the predetermined condition includes that a wireless channel usage rate of the wireless transceiver device is less than a usage rate threshold.

20. The wireless transmission mode switching method of claim 11, wherein a first channel bandwidth to which the current transmission mode corresponds is wider than a second channel bandwidth to which each of the plurality of candidate transmission modes corresponds.
